(19) United States
(12) Patent Application Publication
(10) Pub. No.: US 2010/0211375 A1
(43) Pub. Date: Aug. 19, 2010

(54) PROXYING EXTERNAL DATA AND SERVICES INTO APPLICATIONS AS NATIVE TYPES

(75) Inventors: Thomas K. Gersten, Redmond, WA (US); Rolando Jimenez Salgado, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/371,934

(22) Filed: Feb. 17, 2009

(51) Int. Cl. G06F 9/455; G06F 17/30

(52) U.S. Cl. 703/27; 707/E17.032; 707/E17.005

(57) ABSTRACT

Architecture that provides the capability to receive types associate with external data and services and then integrate (or blend) these types into other applications such as office suite applications and collaboration applications. The result is the user is given a complete view of a given business problem and allows the user to complete tasks and plans in a single context. The architecture creates new defined types and blends these new defined types with the host native types of the particular host application (e.g., office application, collaboration application, etc.) so the user can operate from within a single context. Formal and pre-existent business applications, as well as external data sources are seamlessly proxied into the everyday productivity tools and/or collaboration environment to enable the user complete work as a single work stream within a known user experience with expected behaviors.

### BACKGROUND

While information workers are familiar with office productivity applications related to email, contacts, word processing, spreadsheets, collaboration, etc., the worker is being thrust into interacting with more formalized backend systems (e.g., line-of-business—either commercial or homegrown) using proprietary user experiences (UXs), and which are disconnected from the productivity tools the worker uses on daily basis. This disconnect reduces productivity and increases data errors because of data duplication and recapturing. Custom solutions built to address these needs are expensive and simply add to the complexity of new destinations (e.g., new applications, new websites) the user has to know and add to the learning curve of new UXs. Moreover, existing systems do not integrate external data and services or processes into applications as native types.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides the capability to receive content types from external sources and then integrate (or blend) these types into other applications such as office suite applications and/or collaboration applications. The result is the user is given a complete view of a given business problem, for example, and allows the user to complete tasks and plans in a single context.

The architecture creates new defined types for the external data and services of the external sources and blends these new defined types with the host native types of the particular host application (e.g., office application, collaboration application, etc.) so the user can operate from within a single context. The new defined types can be used as if native to the system. Formal and pre-existent business applications, as well as external data sources are seamlessly proxied into the everyday productivity tools and/or collaboration environment to enable the user complete work as a single work stream within a known user experience with expected behaviors.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented interface system in accordance with the disclosed architecture.

FIG. 2 illustrates a more detailed system that employs the proxy component for blending new defined types with existing native types.

FIG. 3 illustrates a system where multiple office applications of an office productivity tool each include proxy components for interacting natively with the external sources.

FIG. 4 illustrates a method of interfacing external data and services to a host application.

FIG. 5 illustrates a method of proxying external data and services for integration into a host application as new defined types.

FIG. 6 illustrates a method of interacting with disparate data and services of external sources.

FIG. 7 illustrates a method of integrating new defined types of external data sources in a productivity suite.

FIG. 8 illustrates a block diagram of a computing system operable to execute new defined types as proxied for external data and services in accordance with the disclosed architecture.

FIG. 9 illustrates a schematic block diagram of a computing environment for processing external data and services at new defined types in host applications.

### DETAILED DESCRIPTION

The disclosed architecture provides the capability to receive external content types and then integrate (or blend) these types into other applications such as office suite applications and collaboration applications. The architecture creates new defined types and blends these new defined types with the host native types of the particular host application (e.g., office application, collaboration application, etc.), as if native to the system, so the user can operate from within a single context. The end result of blending a proxy component with a native type is an extended native type. For example, a “contact” item that is extended with customer information can be understood as a “customer contact”, where “contact” is the “native type” and “customer contact” is the extended native type. The extensions on the native type are made so that the extensions continue to appear as integral elements of the base or existing “native type” from the host application perspective (as opposed to task panes and surround-type extensions). Thus, from the user perspective the new defined types integrated into host application information can be simply a contact, or a task, or customer, for example. The changes made by the user are propagated back to the backend system (external source) so the backend system is updated. Additionally, updates from the backend are reflected in the host application (e.g., a personal information management (PIM) contact).

This is in contrast to existing systems that put external information “around” the host application in the form of a task pane or adjoining regions in the application to present information. The disclosed architecture integrates the new defined types as contextual activation such that from a user perspective there is no visible line between what is internal and what is external—it looks the same.

The seamless introduction of external data and services can continue to increase over time, for example, to enhance the user experience (such as working offline or in draft mode). Moreover, the integration of the external data and services allow an ecosystem of software vendors to participate.

With respect to the capabilities support, the architecture includes runtime engines within host applications (e.g., collaboration and the office productivity tool clients). The runtimes execute on the definitions expressed in the tooling to make the external data merged into the host application experiences. The runtimes support symmetrical capabilities across servers and rich clients as the end solutions expand across these environments seamlessly.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

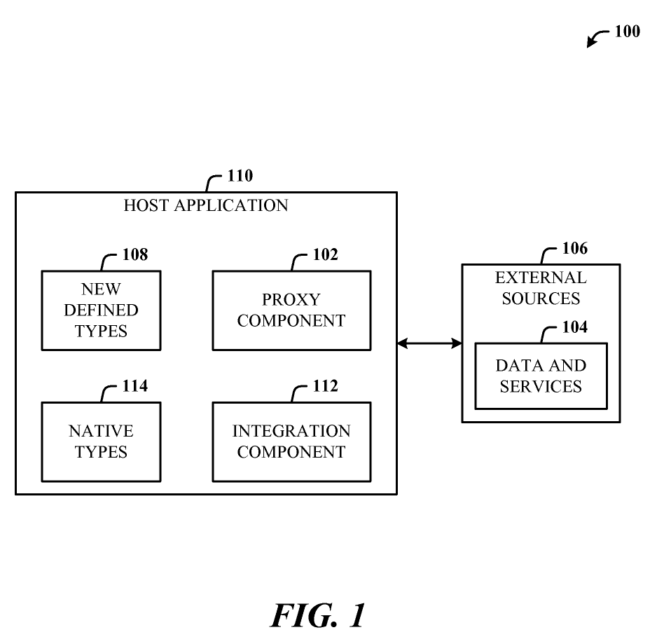

FIG. 1 illustrates a computer-implemented interface system 100 in accordance with the disclosed architecture. The system 100 includes a proxy component 102 for representing external data and services 104 of external sources 106 as new defined types 108 compatible with a host application 110. The system 100 can also include an integration component 112 for integrating the new defined types 108 into the host application 110 with host application native types 114 for seamless interaction with the external data and services of the external sources via the host application 110.

The integration component 112 can include all functionality and modules (e.g., runtime) that facilitate integration of the new defined types into the host application. More specifically, the integration component 112 can include design tools, runtime applications and management tools for making possible the integration of new defined types with existing native types of the host application 110 or other applications to which the host application 110 connects.

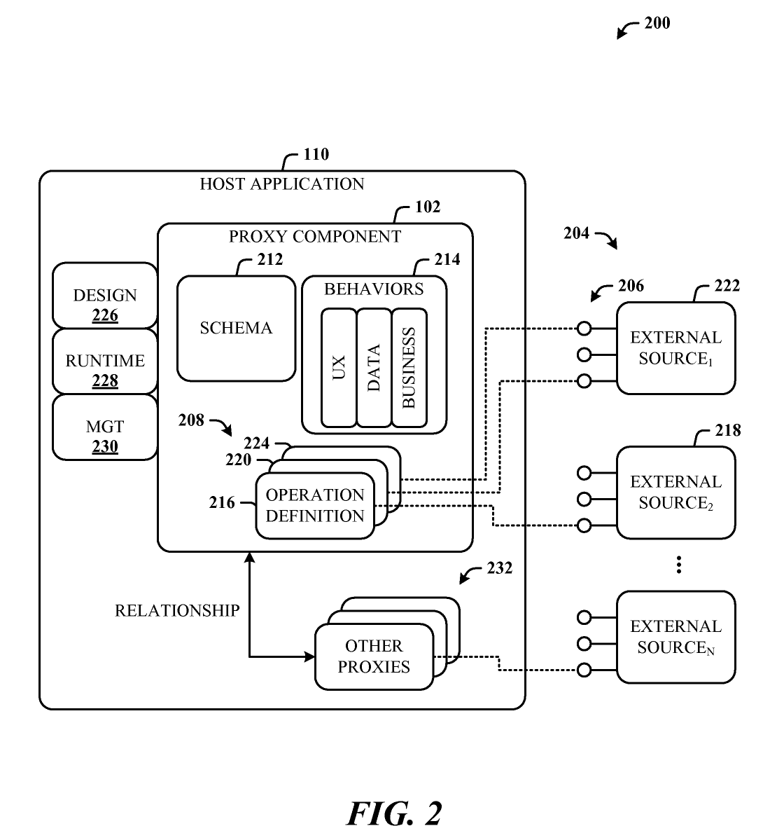

FIG. 2 illustrates a more detailed system 200 that employs the proxy component 102 for blending new defined types with existing native types. The system 200 includes the host application 110 that comprises the tools, models, and runtime capabilities that facilitate integration of the external data and services into client and/or server applications. In other words, some or all of the host application 110 can be included on a server, on a client, or both the server and the client. In one implementation, the host application 110 is an office suite application that interacts with one or more client-based applications (e.g., word processor, spreadsheet, PIM application (e.g., contacts, communications, scheduling, etc.)) of an office productivity suite. In another implementation, the host application 110 is a collaboration server application that interacts with one or more collaboration clients.

The system 200 shows external sources 204 that can be any type of systems which expose services or data through one or more end points 206. The end points 206 are a public interface that can be consumed by the host application 110. The end points 206 can include standards-based interfaces such as web services, SQL (structured query language) entities, connection ports, and/or proprietary interfaces, for example.

The external sources 204 interface to operation definitions 208 of the proxy component 102. The proxy component 102 includes the operation definitions 208, a schema 212, and behaviors 214. An operation definition is a description (e.g., XML) of an end point and the capabilities of the end point. The operation definition includes a description of the semantics of the end point by associating a functional stereotype (defined by the system/architecture) with well-known semantics such as Create, Update, Delete, etc. These stereotypes facilitate the “behavioral blending” described herein. For example, when a user saves a contact item, it is known which external operation to execute, because it is stereotyped. Without stereotypes data could be blended, but not the behaviors, at least simply or seamlessly.

An end point can expose functionality such as CRUD (create, read, update, delete) against data in the associated external source. It is to be understood, however, that the end point functionality is not limited to CRUD, but can also include other functions such as approve, etc.

In other words, the operation definition is a description of the operations the end point is exposing, as well as the information exchange that occurs directly with that end point. Input and output parameters are described as part of the operation definition, and the schemas for the input parameters. This can also include the end point address. Each end point has a physical location that is accessible. For example, in the case of a web service, the web service can be addressed via a URL (uniform resource locator). Essentially, the operation definition includes all of the information needed to connect to an end point and interact with the end point by calling and executing specific operations (e.g., create, delete, etc.).

The proxy component 102 groups together a collection of the operation definitions 208. One operation definition can interface to one external source while other operation definitions interface to a different external source. Here, a first operation definition 216 interfaces to an second external source 218, a second operation definition 220 interfaces to a second external source 222, and a third operation definition 224 interfaces to the second external source 222. Thus, the capability provided by the proxy component 102 addresses the aggregation of system processes and data.

A corporate enterprise typically has more than one system in which the data and processes take place. The system 200 allows these operations to go across systems by enabling a particular proxy component 102 to be sourced by different external sources 204.

This is a limitation that currently exists in the business data catalog. For example, in the business data catalog there is a notion of an entity. However, an entity can only connect to one and only one external source (also referred to as a backend system). In contrast, the system 200 supports the ability to interface to more than one backend and aggregate the data of a single type across the externals sources.

The schema 212 is a description of the data structure for a data or service type that facilitates interaction with the host application data structure. For example, if the type is a customer, the fields that make up the customer can include first name, last name, address, etc. As previously indicated, the behaviors 214 are categorized as UX, data, and business. Other behavior categories can be utilized, as desired. For example, the UX behavior allows the assignment of different user experience behaviors to the proxy component 102.

Once customer has been defined as a data type, that customer can have different UX behaviors within the host application 110. For example, a list of customers can be made and presented as a list for collaboration. The same data type can have a different behavior for an application of an office productivity tool. Accordingly, when the information is connected to a PIM of the office tool, the customer can behave as a contact inside the PIM program. In other words, a data type can have multiple behaviors that define the UX.

The data behavior can define whether the data type can be handled offline, in which case a local copy will exist. This can also be part of the operation definition, as well as whether the data type supports creation and deletion of instances, etc.

The business behaviors are about business rules and validation. There can be rules applied to the schema 212 such as for example if there are two fields that are related (e.g., a customer, customer rating, customer online sales, etc.). The can be a business rule that indicates “a rating cannot be higher than four unless the online sales are higher than some number”. Thus, the business behaviors can be defined as part of the operation definition.

The proxy component 102 is the description of schema, behaviors, and operations on the external sources 204 that allow the host application 110 (or multiple host applications) to interact with the external sources 204 to affect data and processes that occur externally, and at the same time provide a UX that looks and feels similar to the native host application experience.

The proxy component 102 can be a proxy of a business entity, for example, that exists in the external resources 204 (e.g., a representation of a customer in an office productivity tool environment). The proxy component 102 then allows the host application 110 to interact with the business entity.

The design component 226, runtime component 228, and management (Mgt) component 230 are three infrastructure capabilities provided to support the concept of proxies (e.g., proxy component 102) for the external sources 204. The design component 226 includes the tools that facilitate the ability to design the proxy component 102. The runtime component 228 facilitates the creation of runtime programs in one or both of the server and/or the client, the runtimes understand what the proxy component 102 is and represent the proxies in the way intended to be represented based on how the proxy is described.

For example, the runtime can include a component inside a PIM application of the office tools (or similar program of a collaboration application) that assists in reading data and services (processes) of the external sources 204, starts the content of the data and services in UX to the user of the PIM contact, uses the right form of definitions, and uses the correct schema mappings. In other words, there can be a runtime component in the PIM, a runtime component in each of the office productivity tools, and a runtime component in other host applications such as a collaboration application. The proxy component 102 provides the behaviors 214, definitions 208, and schema 212 for each of the end points 206 and external sources 204, and the design component 226, runtime component 228, and management component 230 function to surface the data and/or services of the external sources 204 as integral parts of the host application 110.

Further illustrated is the presence of one or more relationships between the proxies (the proxy component 102 and other proxies 232). Thus, there can be multiple proxy components for the host application 110, and moreover, relationships can be defined between one or more of the proxies to create richer scenarios using a collection of external types for data and services. For example, to see customer as a content type (defined as a proxy component with behaviors, schema, and operation definitions) and then the orders for the customer (defined as a different proxy component with behaviors, schema, and operation definitions), an association (relationship) can be created therebetween that allows navigation between customers and orders. The orders type may have different UX behaviors than the orders type. The orders may be represented only as part of a collaboration application, but the customers are represented in an office PIM application as contacts. Thus, the behaviors are described in each proxy component, and the association allows navigation from a contact in the PIM application to the list of orders for the customer in the collaboration application.

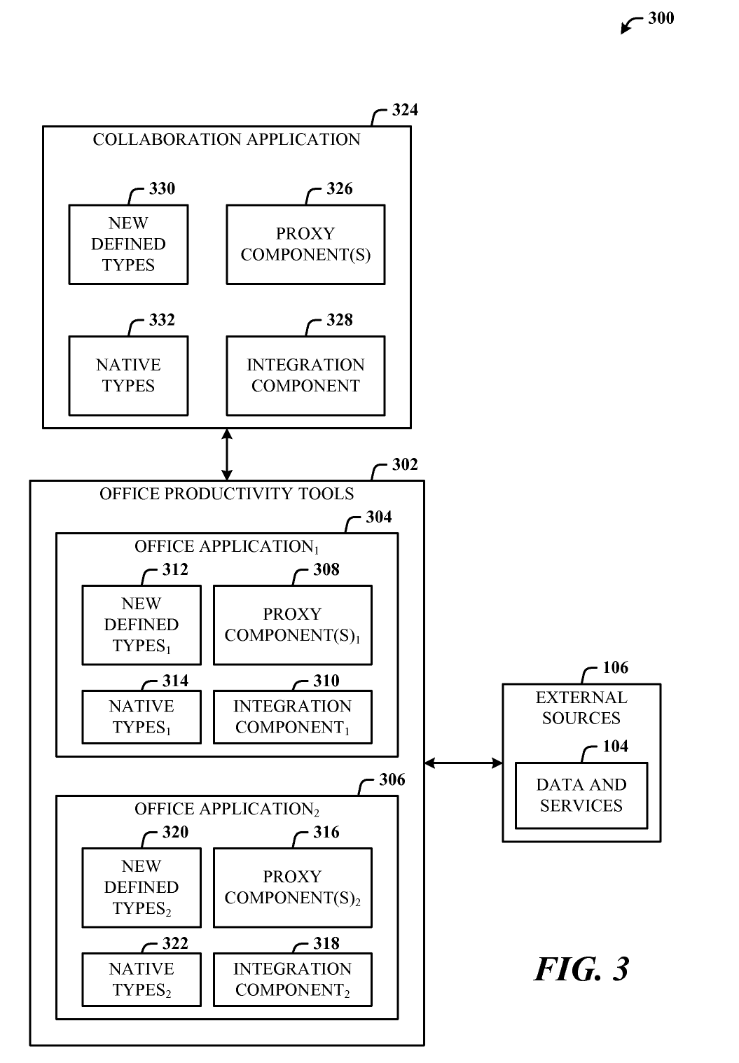

FIG. 3 illustrates a system 300 where multiple office applications of an office productivity tool 302 each include proxy components for interacting natively with the external sources 106. Here, the office productivity tools 302 include a first office application 304 and a second office application 306. The first office application 304 includes one or more first proxy component(s) 308 that describe the data and services 104 of the external sources 106 such that a first integration component 310 integrates data and/or services of the external sources 106 as new defined types 312 with the existing native types 314 of the first office application 304. Similarly, the second office application 306 includes one or more second proxy component(s) 316 that describe the data and services 104 of the external sources 106 such that a second integration component 318 integrates data and/or services of the external sources 106 as new defined types 320 with the existing native types 322 of the second office application 306.

The productivity tools 302 interface to a collaboration application 324 that includes one or more proxy component(s) 326 that describe the native types and new defined types of the productivity tools 302. An integration component 328 can integrate the first and second native types (314 and 322) and the first and second new defined types (312 and 320) as new defined types 330 with the existing native types 332 of the collaboration application 324. Thus, new defined types not already surfaced in the collaboration application 324 can be integrated as exposed new defined types for seamless interaction by a user of the collaboration application 324.

Put another way, a computer-implemented interface system is provided that comprises proxy components of a host application for representing external data and services of external sources as new defined types compatible with the host application, the proxy components including, operation definition components that describe operations exposed by the external sources, a schema component that describes data structures of end points of the external sources, and a behaviors component that describes a user experience behavior, data behavior, and business behavior of the external data and services. The system further comprises an integration component of the host application for integrating the new defined types with existing native types for seamless interaction with the external data and services of the external sources via the host application.

The host application can be an office productivity application or a collaboration application. The operation definitions describe operations exposed by data and services of different external sources. The proxy component is associated with one or more other proxy components, the relationship facilitating interaction between the data and services of disparate end points.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

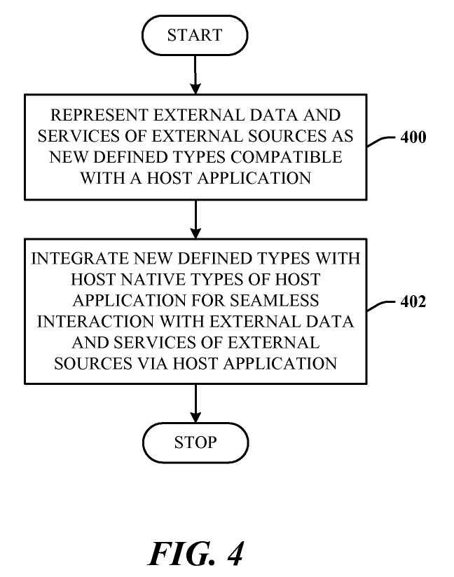

FIG. 4 illustrates a method of interfacing external data and services to a host application. At 400, external data and services of external sources are represented as new defined types compatible with a host application. At 402, the new defined types are integrated with host native types of host application for seamless interaction with external data and services of external sources via the host application.

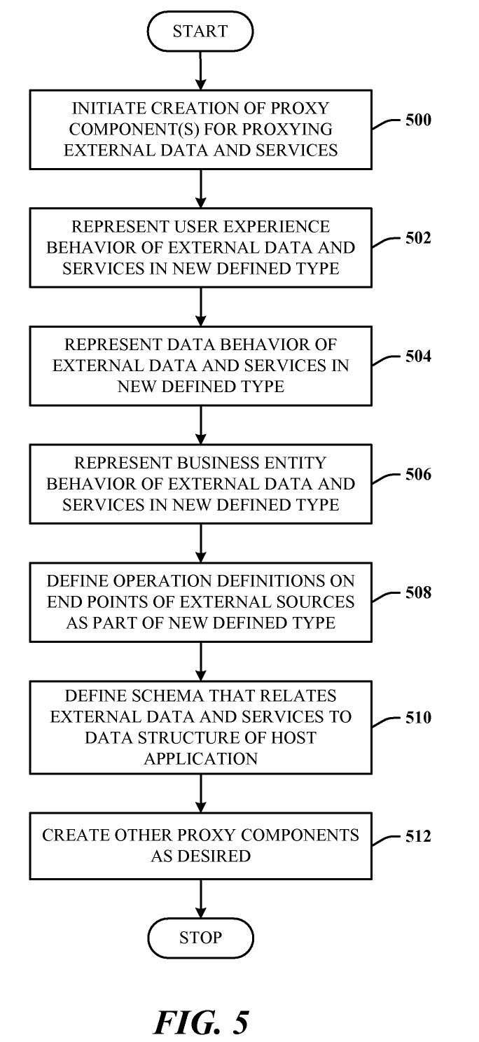

FIG. 5 illustrates a method of proxying external data and services for integration into a host application as new defined types. At 500, creation of a proxy component(s) is initiated for proxying external data and services. At 502, a user experience behavior of the external data and services is represented in a new defined type. At 504, a data behavior of the external data and services is represented in a new defined type. At 506, a business entity behavior of the external data and services is represented in a new defined type. At 508, operations on end points of the external sources are defined as part of the new defined types. At 510, a schema is defined that relates the external data and services to the data structure of the host application. At 512, other proxy components can be created as desired.

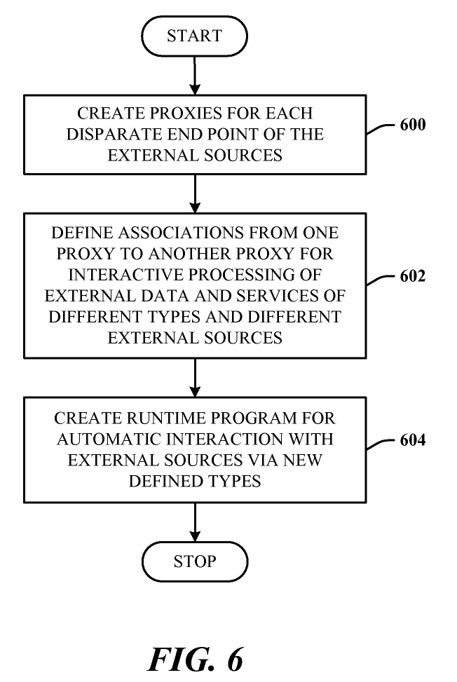

FIG. 6 illustrates a method of interacting with disparate data and services of external sources. At 600, proxies for each disparate end point of the external sources are created. Each proxy defines a schema, behaviors, and operation definitions for the end points. At 602, associations from one proxy to another proxy are defined for interactive processing of the external data and services of different types and different external sources. At 604, a runtime program is created for automatic interaction with the external sources via new defined types.

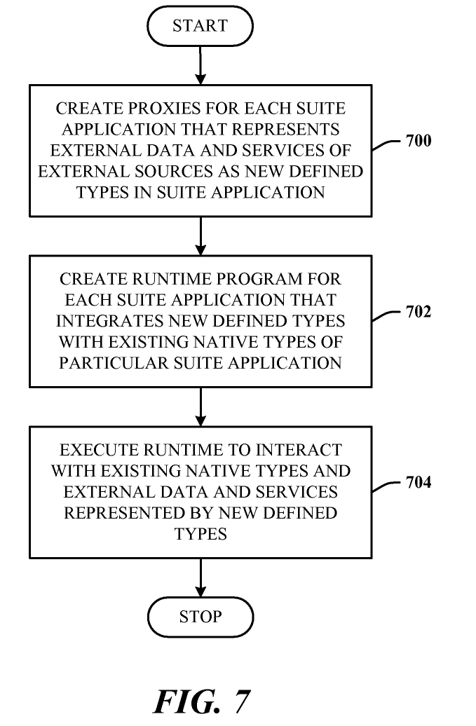

FIG. 7 illustrates a method of integrating new defined types of external data sources in a productivity suite. At 700, proxies are created for each suite application that represent external data and services of external sources as new defined types in the suite application. At 702, a runtime program is created for each suite application that integrates the new defined types with the existing native types of the particular suite application. At 704, the runtime is executed to interact with the existing native types and external data and services represented by the new defined types

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

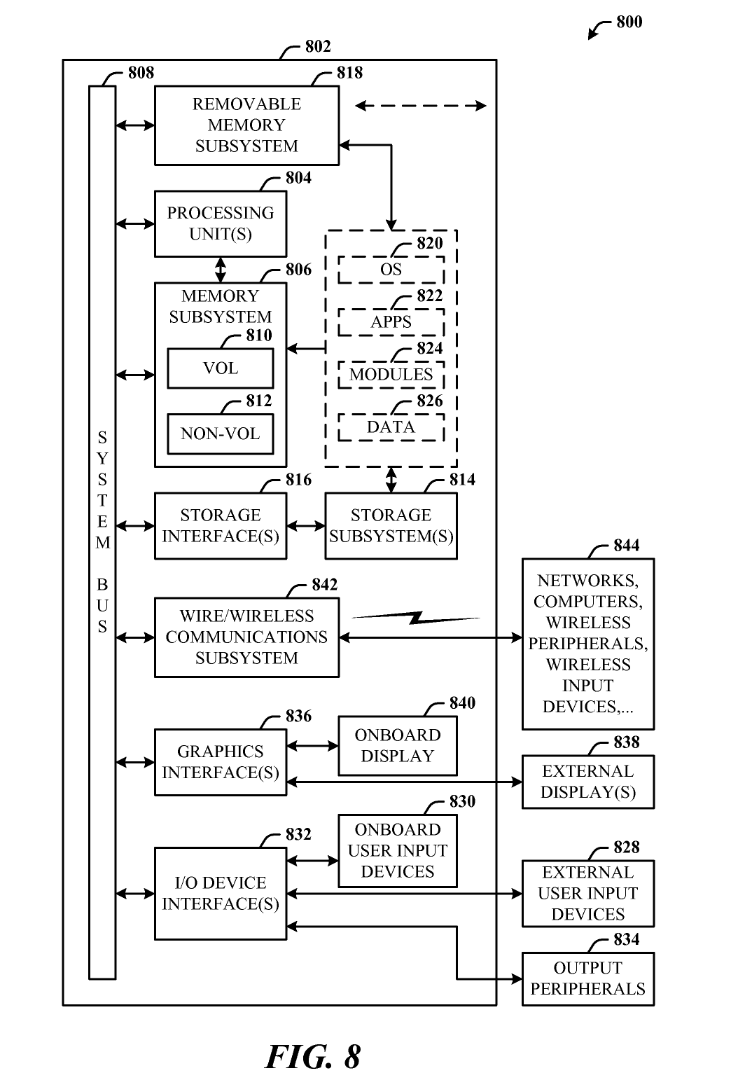

Referring now to FIG. 8, there is illustrated a block diagram of a computing system 800 operable to execute new defined types as proxied for external data and services in accordance with the disclosed architecture. In order to provide additional context for various aspects thereof, FIG. 8 and the following discussion are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the memory subsystem 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes storage subsystem(s) 814 and storage interface(s) 816 for interfacing the storage subsystem(s) 814 to the system bus 808 and other desired computer components. The storage subsystem(s) 814 can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a removable memory subsystem 818 (e.g., flash drive form factor technology), and/or the storage subsystem(s) 814, including an operating system 820, one or more application programs 822, other program modules 824, and program data 826. The computer 802 can be a client machine or a server machine. The one or more application programs 822, other program modules 824, and program data 826 can include the system 100 of FIG. 1, the system 200 of FIG. 2, the system 300 of FIG. 3, and the methods represented in the flow charts of FIGS. 4-7, for example.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Computer readable media can be any available media that can be accessed by the computer 802 and includes volatile and non-volatile media, removable and non-removable media. For the computer 802, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP) using logical connections via a wired/wireless communications subsystem 842 to one or more networks and/or other computers. The other computers can include workstations, servers, routers, personal computers, microprocessor-based entertainment appliance, a peer device or other common network node, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or has other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

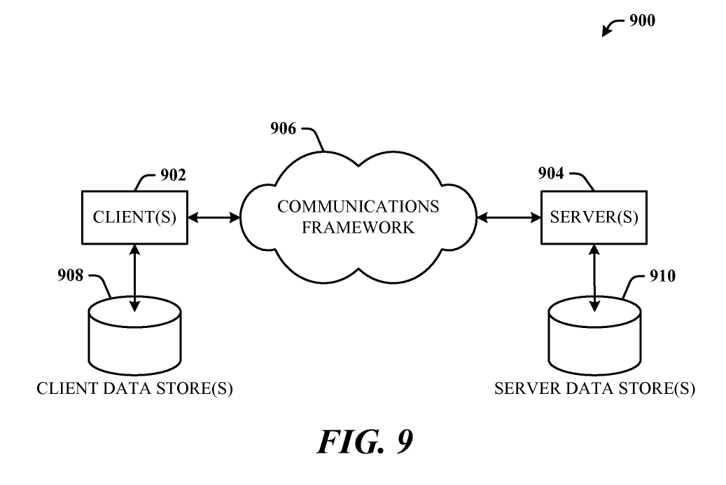

Referring now to FIG. 9, there is illustrated a schematic block diagram of a computing environment 900 for processing external data and services at new defined types in host applications. The environment 900 includes one or more client(s) 902. The client(s) 902 can be hardware and/or software (e.g., threads, processes, computing devices). The client(s) 902 can house cookie(s) and/or associated contextual information, for example.

The environment 900 also includes one or more server(s) 904. The server(s) 904 can also be hardware and/or software (e.g., threads, processes, computing devices). The servers 904 can house threads to perform transformations by employing the architecture, for example. One possible communication between a client 902 and a server 904 can be in the form of a data packet adapted to be transmitted between two or more computer processes. The data packet may include a cookie and/or associated contextual information, for example. The environment 900 includes a communication framework 906 (e.g., a global communication network such as the Internet) that can be employed to facilitate communications between the client(s) 902 and the server(s) 904.

Communications can be facilitated via a wire (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented interface system, comprising:
a proxy component for representing external data and services of external sources as new defined types compatible with a host application; and
an integration component for integrating the new defined types into the host application with host application native types for seamless interaction with the external data and services of the external sources via the host application.

2. The system of claim 1, wherein the host application is an office suite application.

3. The system of claim 1, wherein the host application is a collaboration application.

4. The system of claim 1, wherein the proxy component and the integration are part of the host application, the host application a client or a server.

5. The system of claim 1, wherein the proxy component includes behaviors that describes at least one of a user experience behavior, data behavior, or business behavior of the external data and services.

6. The system of claim 1, wherein the proxy component includes operation definitions that describe operations exposed by end points.

7. The system of claim 6, wherein the operation definitions describe operations exposed by data and services of different external sources.

8. The system of claim 1, wherein the proxy component includes a schema that describes a data structure of an end point of an external source.

9. The system of claim 1, wherein the proxy component is associated with one or more other proxy components, the relationship facilitating interaction between the data and services of disparate end points.

10. A computer-implemented interface system, comprising:
proxy components of a host application for representing external data and services of external sources as new defined types compatible with the host application, the proxy components including,
operation definition components that describe operations exposed by the external sources;
a schema component that describes data structures of end points of the external sources; and
a behaviors component that describes a user experience behavior, data behavior, and business behavior of the external data and services; and
an integration component of the host application for integrating the new defined types with existing native types for seamless interaction with the external data and services of the external sources via the host application.

11. The system of claim 10, wherein the host application is an office productivity application or a collaboration application.

12. The system of claim 10, wherein the operation definitions describe operations exposed by data and services of different external sources.

13. The system of claim 10, wherein the proxy component is associated with one or more other proxy components, the relationship facilitating interaction between the data and services of disparate end points.

14. A computer-implemented interface method, comprising:
representing external data and services of external sources as new defined types compatible with a host application; and
integrating the new defined types with host native types of the host application for seamless interaction with the external data and services of the external sources via the host application.

15. The method of claim 14, further comprising representing a user experience behavior of the external data and services in a new defined type.

16. The method of claim 14, further comprising representing a data behavior of the external data and services in a new defined type.

17. The method of claim 14, further comprising representing a business entity behavior of the external data and services in a new defined type.

18. The method of claim 14, further comprising creating a runtime program for automatic interaction with the external sources via the new defined types.

19. The method of claim 14, further comprising defining an association from one proxy component to another proxy component for interactive processing of the external data and services of different types.

20. The method of claim 14, further comprising defining operations on end points of the external sources as part of the new defined types.
